(19) United States
(12) Patent Application Publication
(10) Pub. No.: US 2025/0208310 A1
(43) Pub. Date: Jun. 26, 2025

(54) PREDICTING SYSTEMS TRACTS FROM A SEA LEVEL CURVE

(71) Applicant: Landmark Graphics Corporation, Houston, TX (US)

(72) Inventor: Andrew Davies, Abingdon (GB)

(21) Appl. No.: 18/392,206

(22) Filed: Dec. 21, 2023

(51) Int. Cl. G01V 1/28

(52) U.S. Cl. CPC G01V 1/282; G01V 2210/6161; G01V 2210/661

(57) ABSTRACT

In some implementations, a method comprises generating a training dataset including a plurality of sample systems tracts each associated with a respective sample rate of change of subsidence and a respective sediment supply. The method also may comprise training a learning machine to indicate predicted systems tracts for wells based on the plurality of sample system tracts and their respective sample rate of change of subsidence and respective sample sediment supplies.

### TECHNICAL FIELD

The disclosure generally relates to the field of subsurface operations and, more specifically, to a tool for washing materials from downhole tubulars.

### BACKGROUND

Sequence stratigraphy is a means of correlating and classifying sediments into distinct packages called “systems tracts”. Each systems tract may have distinct and predictable sedimentary stacking and facies pattern. Hence, sequence stratigraphy may be used for predicting facies patterns and sediment properties away from well data.

### BRIEF DESCRIPTION OF THE DRAWINGS

Aspects of the disclosure may be better understood by referencing the accompanying drawings.

FIG. 1 is an illustration depicting an example stratigraphic sequence comprising systems tracts.

FIG. 2 is a block diagram illustrating an example system for making geologic predictions.

FIG. 3 is a graph illustrating predicted system tracts.

FIG. 4 is a graph showing a relationship between geological time and depth at a location of interest.

FIG. 5 includes graphs showing how a wireline is modified using the relationship between geological age and depth.

FIG. 6 includes graphs showing a well transformed into geological age, with a subsidence curve, eustatic curve, sediment supply curve and resulting systems tracts.

FIG. 7 is a graph illustrating relationships between predicted systems tracts and well information.

FIG. 8 is a flow diagram illustrating operations for predicting systems tracts from a sea level curve.

FIG. 9 is a flow diagram illustrating a method for predicting systems tracts.

FIG. 10 is a perspective view of an example drilling rig system.

### DESCRIPTION

The description that follows includes example systems, methods, techniques, and operational flows that embody aspects of the disclosure. However, this disclosure may be practiced without these specific details. For clarity, some well-known structures and techniques have been omitted.

Sequence stratigraphy is a means of correlating and classifying sediments into distinct packages called “systems tracts”. As each systems tract has distinct and predictable sedimentary stacking and facies pattern, sequence stratigraphy may be a powerful tool for predicting facies patterns and sediment properties away from well data. It can therefore be used to improve subsurface models and reduce uncertainty in interpretations. However, the interpretation of systems tracts in well data can be challenging as the signal varies spatially and temporally. Sedimentary systems may be controlled by the interplay between accommodation space (related to global sea level and subsidence) and sediment supply. Locally high subsidence or high sediment supply may overwhelm any sea level control. Sedimentary systems also may be influenced by autocyclic factors (such as noise introduced by factors such as turbidite fan switching or river avulsion) that can be mistaken for systems tracts but are just local features. Therefore, sequence stratigraphic interpretation may be incorrectly applied.

Some implementations make sequence stratigraphic interpretations that may be used in planning, operating, or otherwise working with wells. Some implementations include a learning machine configured to analyze a global (eustatic) or relative (local) sea level curve, sedimentation supply curve, and subsidence curve to predict systems tracts near a well. In some implementations, the learning machine is implemented via a neural network. However, the learning machine may be implemented via a decision tree, support vector machine, or any other components suitable for implementing the functionality described herein. The learning machine may be trained using data from forward stratigraphic models. After training, the learning machine may predict which systems tracts are present based on the local sediment supply and subsidence for a given eustatic curve. Such predictions may aid users (such as humans, other systems, etc.) in understanding well log signatures and placing sequence stratigraphic surfaces correctly.

Some implementations utilize sequence stratigraphy for predicting facies patterns and sediment properties away from well data. Some implementations may be used to improve subsurface models from exploration to reservoir scale. Some implementations therefore support the goal of building superior, more geologically plausible subsurface models at all scales, helping people (or systems) make more informed decisions and maximize the value of their assets.

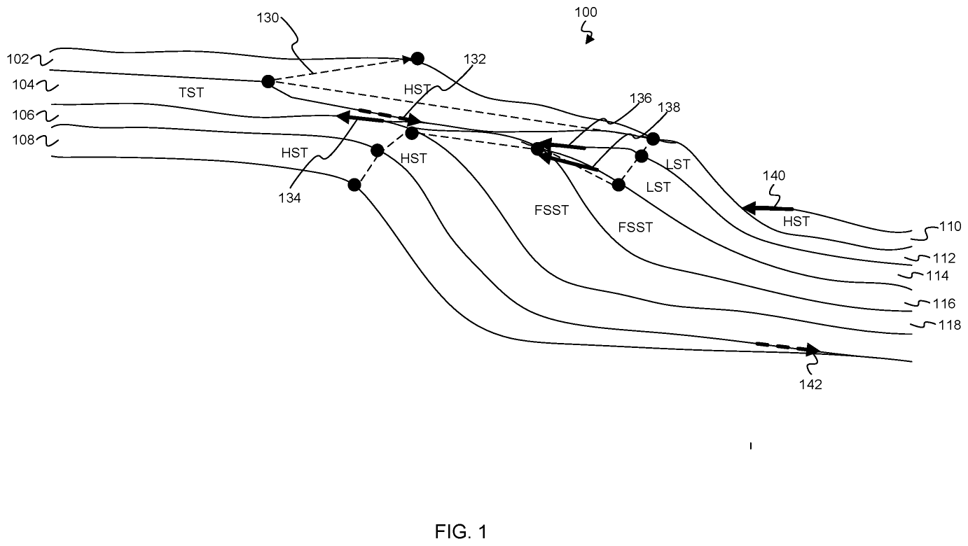

This disclosure continues with a brief discussion of systems tracts. FIG. 1 is an illustration depicting an example stratigraphic sequence comprising systems tracts. Systems tracts may form through changes in accommodation (the interplay of tectonic subsidence/uplift and global sea level (eustatic) changes) in relation to sediment supply. System tracts may be classified based on different sediment stacking patterns:
Aggradation—when sediments of the same facies stack broadly vertically. Aggradation develops when accommodation creation and sediment supply are balanced. Aggradation can be displayed by Highstand Systems Tracts (HST) or Lowstand Systems Tracts (LST).
Retrogradation—when facies belts display a landward movement. Retrogradation occurs when accommodation creation outpaces sediment supply, resulting the formation of Transgressive Systems Tracts (TST) Normal progradation—when facies belts move basinward although with accommodation space creation. Normal progradation occurs when sediment supply outpaces accommodation creation. Normal progradation can be displayed by HSTs or LSTs.
Forced progradation—when sediments are forced to prograde, irrespective of sediment supply. Forced progradation is related to the active destruction of accommodation, such as by a drop in relative sea level, resulting in the generation of Falling Stage Systems Tracts (FSSTs).

In FIG. 1, a stratigraphic sequence 100 may represent a cross section of a subsurface formation comprising sediment packages 102-118. The sediment packages 102-118 may be correlated and classified into distinct packages called systems tracts. For instance, sediment packages 106 and 108 make up an HST, sediment packages 116 and 118 make up a falling-stage system tract FSST, sediment packages 112 and 114 make up an LST, and 104 makes up a TST.

As both subsidence/uplift rates and sediment supply vary spatially and temporally, there may be heterogenous development of systems tracts in relation to a single eustatic curve. To help interpret this heterogeneity, some implementations provide a prediction of the system tracts that are likely to develop for the specific subsidence/uplift and sediment supply rate signal for any location.

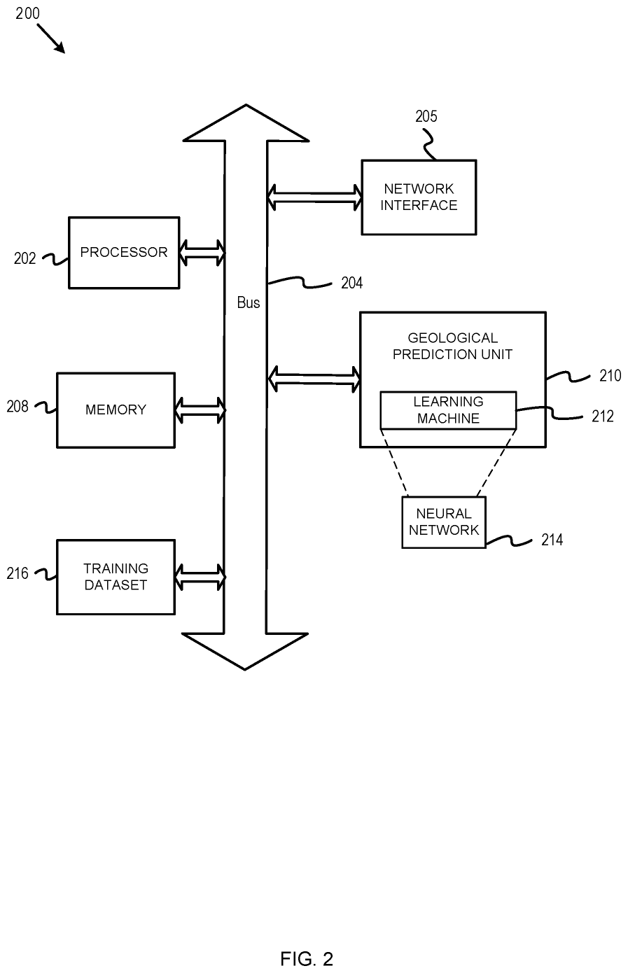

FIG. 2 is a block diagram illustrating an example system for making geologic predictions. In FIG. 2, the system 200 includes a geological prediction unit 210 configured to predict systems tracts as described herein. The geological prediction unit may include a learning machine 212. Before using the learning machine 212 to make predictions about systems tracts, the learning machine 212 may be trained using the training dataset 216. The training dataset 216 may include information on the rates of change of accommodation (subsidence and eustasy), sediment supply, and resulting systems tracts. In some implementations, the training dataset 216 is generated from geological process simulators (such as using forward stratigraphic modelling (FSM)). In some datasets that were created with FSM, systems tracts may be identified via change in coastline position, change in “accommodation” (such as subsidence), or other suitable indicia. The training dataset 216 may be created from analyzing FSM simulations to identify systems tracts for any rate of change of sea level, subsidence rate, and sediment supply. Other factors, including sediment compaction, isostatic loading and initial bathymetry may also be included. The analysis also may use any other information suitable for identifying systems tracts. However, the training dataset 216 may be generated from other means (different than simulations) such as modern observations, flume experiments, and other information. Using the training dataset 216, the geology prediction unit 210 may generate the learning machine 216. The learning machine 212 may implement any suitable machine learning model. The learning machine 212 may predict a systems tract for any given eustatic curve, subsidence/uplift rate, and sediment supply. As there are different systems tract classification schemes, the geological prediction unit 210 may generate different learning machines 212 (or different learning machine models) for different classification schemes. In some implementations, the learning machine 212 may utilize any sequence stratigraphic classification scheme or make progradation/aggradation/retrogradation classifications. In some implementations, the learning machine 212 may be implemented via one or more neural networks 214. Any suitable neural network 214 (such as feedforward neural networks) may be utilized to implement the learning machine 212. In some implementations, the learning machine 212 may be implemented using any suitable machine-learning algorithm and structure. The system 200 also may include one or more processors 202, memory 208, and bus 204.

After training, the learning machine 212 may be used to make geological predictions such as predictions about systems tracts. The learning machine 212 may make predictions based on specific input data such as user-provided information or information otherwise available to the geological prediction unit. The input data may include a location of interest (such as a well), time of interest, and an eustatic curve. The geological prediction unit 210 may calculate subsidence/uplift rates through time for the location of interest. This may be achieved using any suitable method such as back-stripping. In some embodiments, a relative sea level curve is used as input, in which case subsidence rates need not be calculated. Next, the geological prediction unit 210 may determine sediment supply through time such as by using a mass balance analysis of thickness maps, predictive models, analog identification, or via a user-defined technique.

As the rates (such as the rate of change of eustasy in millions/thousands of years) may serve as a basis for geological predictions, the geological prediction unit 210 may modify rates (e.g., m/Ma) in the input data to match those used in the training dataset 216. The geological prediction unit also may define a sampling interval. Next, the input data are provided to the learning machine 212. The learning machine 212 may predict system tracts based on the input data.

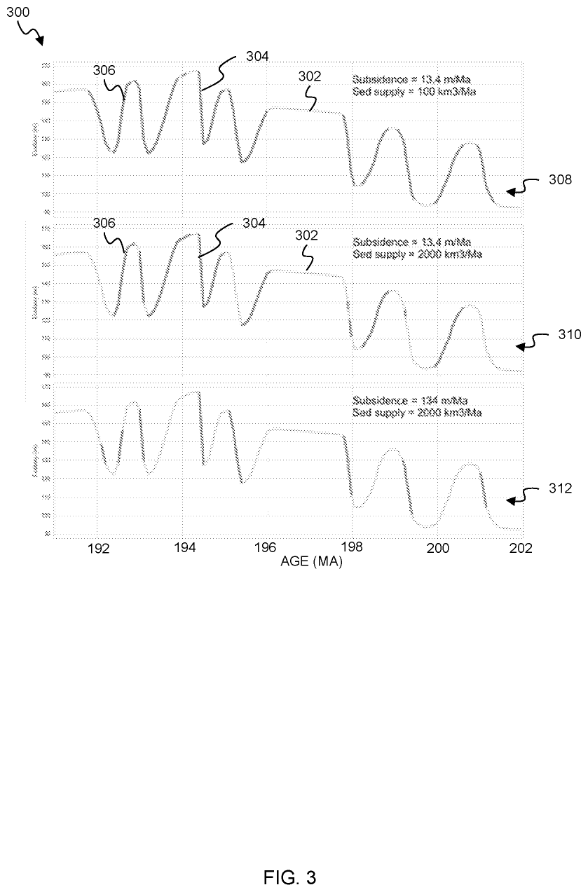

FIG. 3 is a graph illustrating predicted system tracts. In FIG. 3, the graph 300 includes curves 308, 310, and 312 each indicating systems tracts at the location of interest. In the graph 300, the x-axis indicates age in Ma and the y-axis indicates eustasy ranging from 90 to 170. The curve 308 indicates HSTs/LSTs 302, FSSTs 304, and TSTs 306 based on subsidence of 13.4 m/Ma and a sedimentary supply of 100 km³/Ma. The curve 310 indicates HSTs/LSTs 302, TSTs 304, and FSSTs 306 based on subsidence of 13.4 m/Ma and a sedimentary supply of 2000 km³/Ma. The curve 312 indicates HSTs/LSTs 302, TSTs 304, and FSSTs 306 based on subsidence of 134 m/Ma and a sedimentary supply of 2000 km³/Ma. These predictions allow users to understand which systems tracts are likely to be present in their succession and assist in determining which sequence stratigraphic surfaces (e.g., MFS, SB, MRS) may be added.

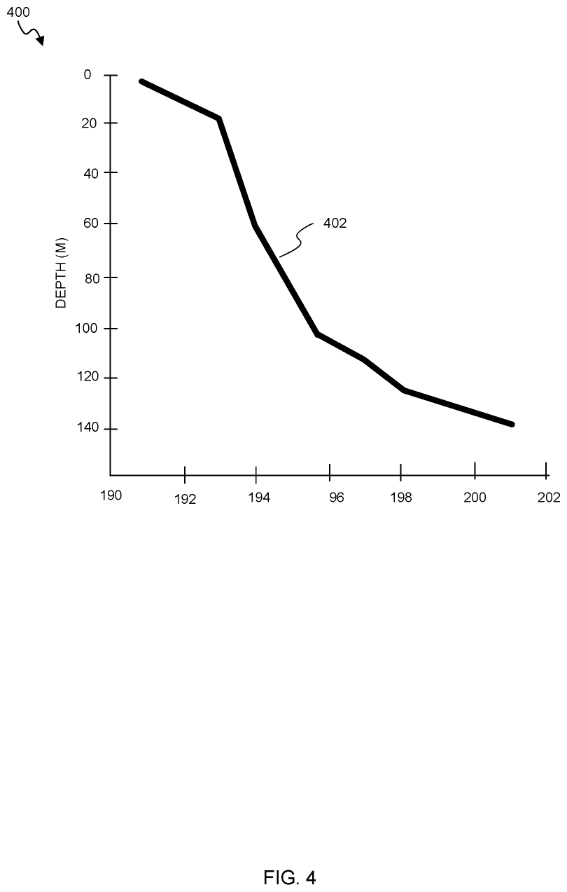

For a location of interest, the geological prediction unit 210 may convert the observed geological succession (in thickness or depth) into geological time using information that relates depth to geological time (if such information is available). FIG. 4 is a graph showing a relationship between geological time and depth at a location of interest. In FIG. 4, the graph 400 includes a curve 402 indicating a relationship between depth at a location of interest and geological age. If the geological prediction unit 210 has access to information with which it can determine the depth to geological age relationship, it may determine and present additional information about the location of interest (as described further herein). However, if the geological prediction unit 210 cannot determine a relationship between depth and geological age, it may omit operations that determine and present the additional information.

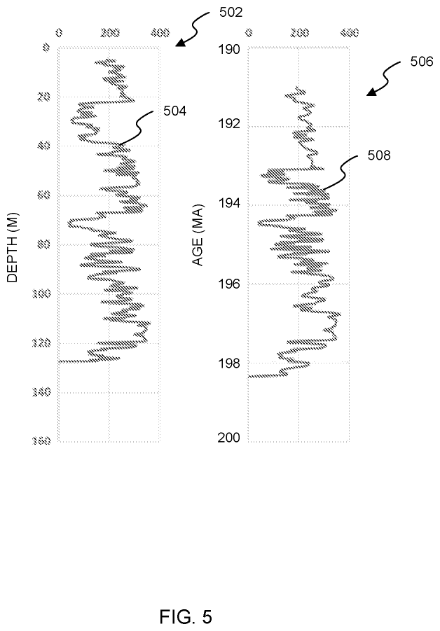

After determining a relationship between time and depth, the geological prediction unit 210 may convert the observed geological succession (in thickness or depth) into geological time. For example, the geological prediction unit 210 may determine a relationship between depth and geological age for the location of interest using chronostratigraphic information (such as biozones, formation tops, or other suitable information), information from regional synthesis (such as regional depth mapping), or seismic horizon information. FIG. 5 includes graphs showing a relationship between geological age and depth. In FIG. 5, a graph 502 includes a curve 504 indicating the strength of a Gamma Ray signal over a range of depth values (0-160 meters). Using the relationship between age and depth (such as the relationship from graph 400), the geological prediction unit 210 may convert the depth scale (x-axis) of graph 502 into an age scale (as shown in graph 506). The graph 506 includes a curve 508 indicating strength of the Gamma Ray signal for geological age values ranging from 190 Ma. to 200 Ma. In some implementations, the time-depth relationships may be augmented by a tool to determine numerical ages for geological events (such as techniques described in U.S. Pat. No. 11,397,278 B2).

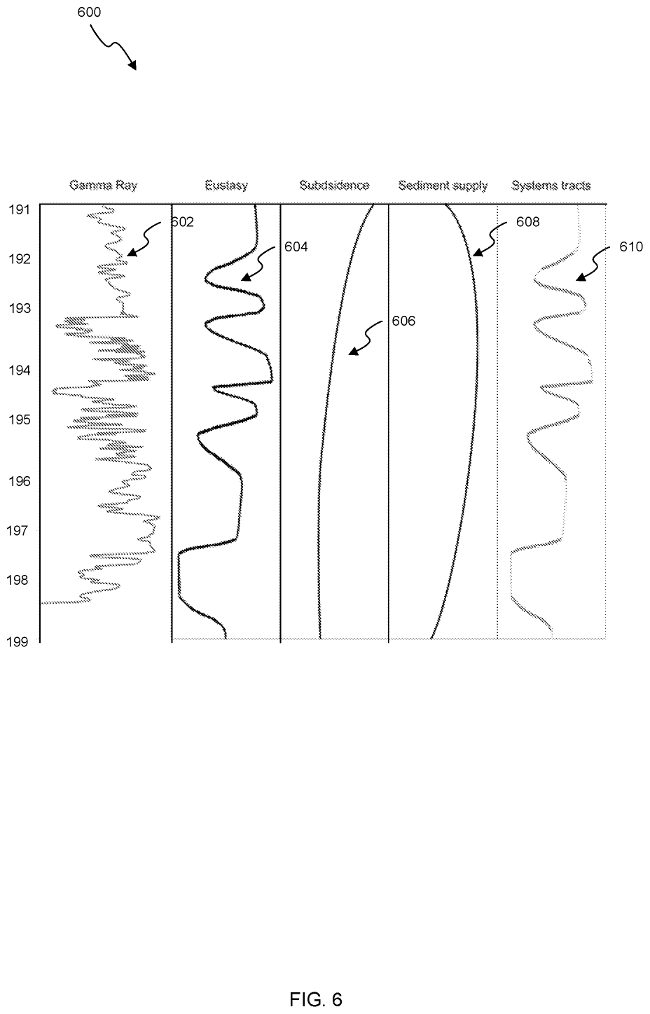

After determining the relationship between geological age and depth, the geological prediction unit 210 may utilize the age-depth relationship to enable direct comparison to an eustatic curve. FIG. 6 includes graphs showing a relationship between depth, time, an eustatic curve, and systems tracts. In FIG. 6, a graph 600 includes, for the location of interest, a Gamma Ray signal curve 602, an eustatic curve 604, a subsidence curve 606, a sediment supply curve 608, and system tracts prediction 610. For the graph 600, there is a universal y-axis indicating geological age in Ma (191-199 Ma.). However, each respective curve 602-610 has a unique x-axis indicating a magnitude of the respective curve. The Gamma Ray signal curve 602 may be similar to the curve 508 (see FIG. 5) indicating Gamma Ray signal strength for geological age values. The eustatic curve 604, subsidence curve 606, and sediment supply curve 608 may indicate respective magnitudes (values) relevant to the location of interest. The systems tracts curve 610 indicates a predication (such as by the geological prediction unit 210) about the type, age, and depth of systems tracts near the location of interest. The methodologies described herein can be used as part of automated well correlation/interpretation approaches. With the time/depth conversion complete, the geological prediction unit 210 may determine where to place sequence stratigraphic surfaces and determine what events are likely to be regionally significant versus local noise.

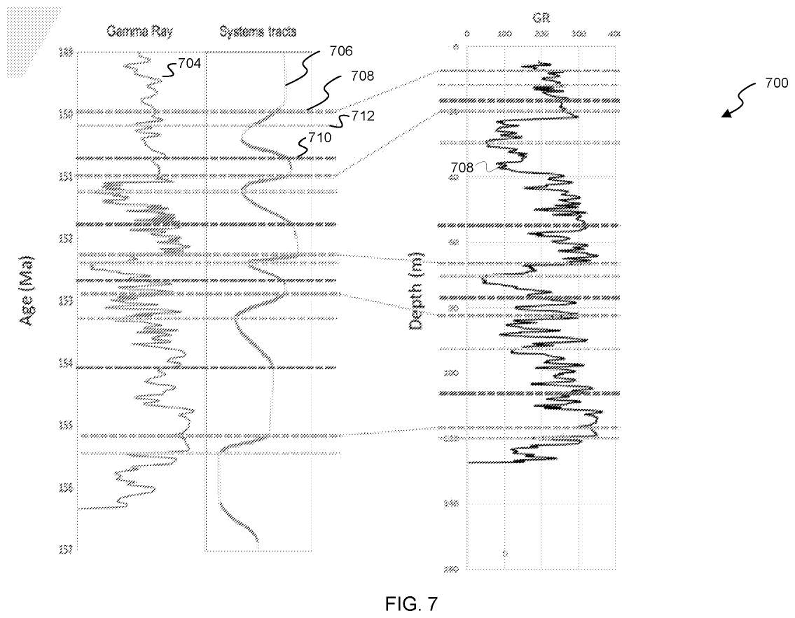

FIG. 7 is a graph illustrating relationships between predicted systems tracts and well information. In FIG. 7, a graph 700 shows relationships between a Gamma Ray curve 704 (with respect to age), predicted systems tracts 706, and a Gamma Ray curve 708 (with respect to depth). The lines 708 represent maximum flood surfaces. The lines 710 represent sequence boundaries. The lines 712 represent maximum regressive surfaces. The lines 708, 710, and 712 may represent systems tract boundaries (such as where a TST becomes an HST).

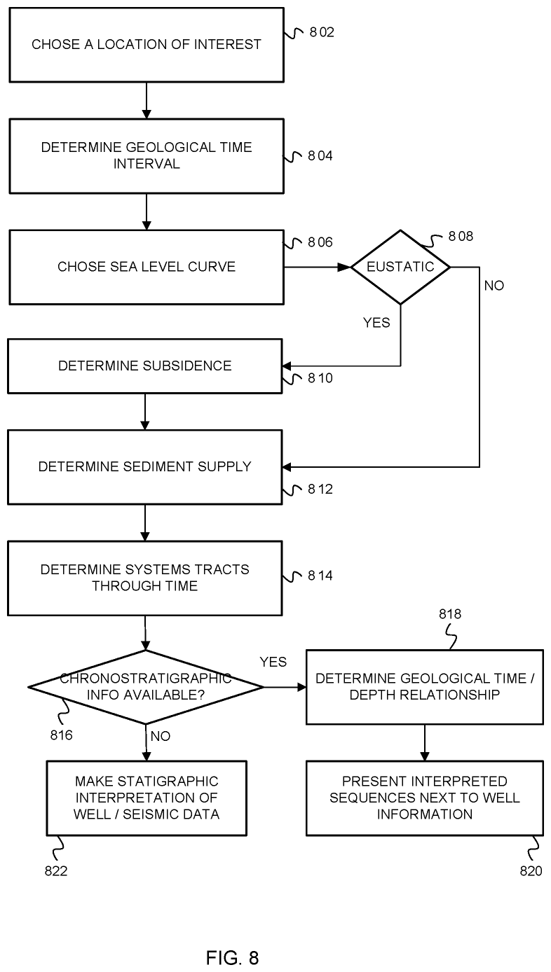

In some implementations, the geological prediction unit 210 may achieve one or more aspects of the functional described herein by performing operations shown in FIG. 8. FIG. 8 is a flow diagram illustrating operations for predicting systems tracts from a sea level curve. In FIG. 8, flow 800 begins a block 802.

At block 802, the geological prediction unit 210 chooses a location of interest such as a well. At block 804, the geological prediction unit 210 determines a geological time interval. At block 806, the geological prediction unit 210 chooses a sea level curve. The sea level curve may be a local sea level curve or a eustatic curve. If the sea level curve is an eustatic curve, flow continues at block 810. Otherwise, the flow continues at block 812.

At block 810, the geological prediction unit 210 determines subsidence for the location of interest. For example, the geological prediction unit 210 may choose a subsidence curve (for example, see discussion of the subsidence curve 606 in reference to FIG. 6). At block 812, the geological prediction unit may determine sediment supply (for example, see discussion of sediment supply curve 608 in reference to FIG. 6). At block 814, the geological prediction unit may determine whether chronostratigraphic information is available. If chronostratigraphic information is available, the flow continues at block 818. Otherwise, the flow continues at block 822.

At block 818, the geological prediction unit determines a relationship between geological time and depth (for example, see discussion of FIG. 4). At block 820, the geological prediction unit 210 may present interpreted sequences for the location of interest. For example, the geological prediction unit 210 may present the graph 600 (see discussion of FIG. 6).

At block 822, the geological prediction unit 210 or a user may make stratigraphic interpretations of the well data and seismic data.

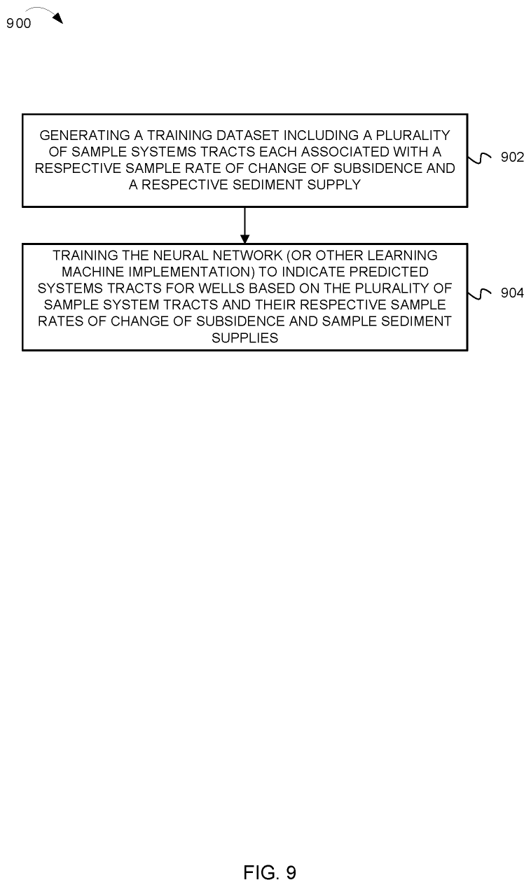

Some implementations of the geological prediction unit 210 may perform the operations shown in FIG. 8. FIG. 9 is a flow diagram illustrating a method for predicting systems tracts. The method may include generating a training dataset including a plurality of sample systems tracts each associated with a respective sample rate of change of subsidence and a respective sediment supply. The method also may include training the neural network (or other machine learning algorithm) to indicate predicted systems tracts for wells based on the plurality of sample system tracts and their respective sample rates of change of subsidence and sample sediment supplies.

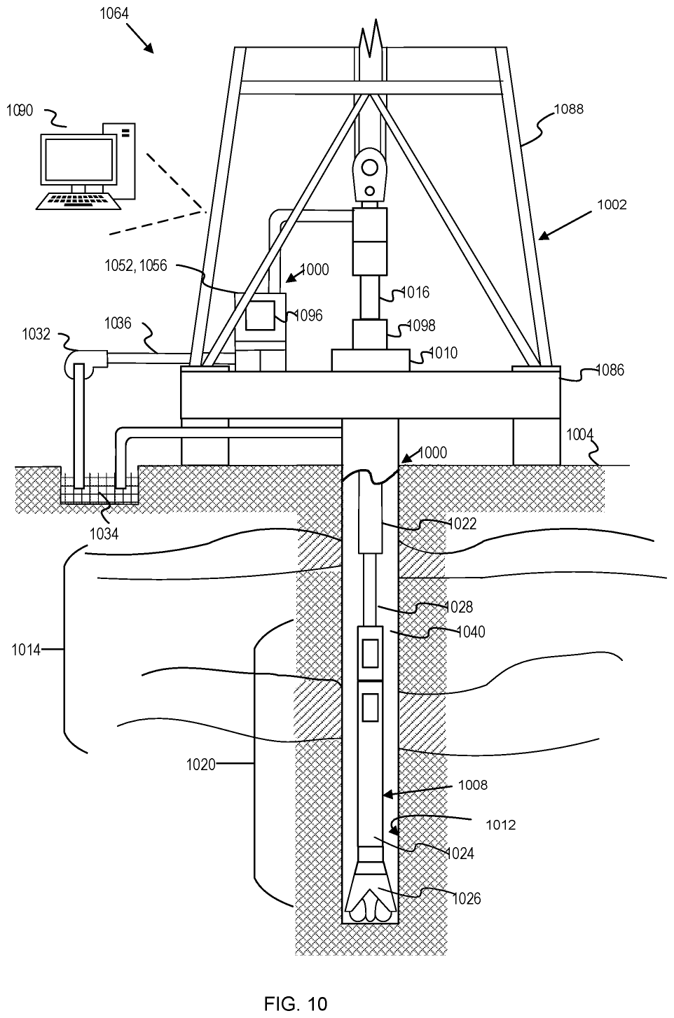

FIG. 10 is a perspective view of an example drilling rig system. For example, in FIG. 10, it can be seen how a system 1064 may form a portion of a drilling rig 1002 located at the surface 1004 of a well 1006. Drilling of oil and gas wells is commonly carried out using a string of drill pipes connected together so as to form a drilling string 1008 that may be lowered through a rotary table 1010 into a wellbore or borehole 1012. Here a drilling platform 1086 may be equipped with a derrick 1088 that supports a hoist. A computer 1090 may be communicatively coupled to any measurement devices attached to the system 1064 and may configured the system 1064 to utilize signal information without prior knowledge of antenna tilt-angles, as described herein. The computer 1090 or any suitable remote computing system (not shown) may include the geological prediction unit 210.

The drilling rig 1002 may thus provide support for the drill string 1008. The drill string 1008 may operate to penetrate the rotary table 1010 for drilling the borehole 1012 through subsurface formations 1014. The drill string 1008 may include a Kelly 1016, drill pipe 1018, and a bottom hole assembly 1020, perhaps located at the lower portion of the drill pipe 1018.

The bottom hole assembly 1020 may include drill collars 1022, a down hole tool 1024, and a drill bit 1026. The drill bit 1026 may operate to create a borehole 1012 by penetrating the surface 1004 and subsurface formations 1014. The down hole tool 1024 (e.g., similar to the logging tool 102) may comprise any of a number of different types of tools including MWD tools, LWD tools, and others.

During drilling operations, the drill string 1008 (perhaps including the Kelly 1016, the drill pipe 1018, and the bottom hole assembly 1020) may be rotated by the rotary table 1010. In addition to, or alternatively, the bottom hole assembly 1020 may also be rotated by a motor (e.g., a mud motor) that may be located down hole. The drill collars 1022 may be used to add weight to the drill bit 1026. The drill collars 1022 may also operate to stiffen the bottom hole assembly 1020, allowing the bottom hole assembly 1020 to transfer the added weight to the drill bit 1026, and in turn, to assist the drill bit 1026 in penetrating the surface 1004 and subsurface formations 1014.

During drilling operations, a mud pump 1032 may pump drilling fluid (sometimes known by those of ordinary skill in the art as “drilling mud”) from a mud pit 1034 through a hose 1036 into the drill pipe 1018 and down to the drill bit 1026. The drilling fluid may flow out from the drill bit 1026 and be returned to the surface 1004 through an annular area 1040 between the drill pipe 1018 and the sides of the borehole 1012. The drilling fluid may then be returned to the mud pit 1034, where such fluid may be filtered. In some embodiments, the drilling fluid may be used to cool the drill bit 1026, as well as to provide lubrication for the drill bit 1026 during drilling operations. Additionally, the drilling fluid may be used to remove subsurface formation 1014 cuttings created by operating the drill bit 1026. It may be the images of these cuttings that many implementations operate to acquire and process.

Any operations of the equipment shown in FIG. 10 may be performed in response to geological predictions made by the geological prediction unit 210. Additionally, planning and implementation of subsurface operations (such as hydraulic fracturing, operating tools, etc.) may be performed in response to predictions made by the geological prediction unit.

FIGS. 1-10 and the functionality described herein are examples meant to aid in understanding example implementations and should not be used to limit the potential implementations or limit the scope of the claims. None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

Some implementations may aspects as described in the following clauses.

Clause 1: An method for generating a training dataset including a plurality of sample systems tracts each associated with a respective sample rate of change of subsidence and a respective sediment supply; and training a learning machine to indicate predicted systems tracts for wells based on the plurality of sample system tracts and their respective sample rate of change of subsidence and respective sample sediment supplies.

Clause 2: The method of clause 1, wherein the learning machine is implemented at a neural network, the method further comprising: determining an input sea level curve indicating rates of change of subsidence and an input sediment supply curve indicating sediment supplies; and determining, via the neural network, one or more predicted systems tracts through time for a well based on the input sea level curve and the input sediment supply curve.

Clause 3: The method of any one or more of clauses 1-2 further comprising determining a location of the well and a geological time interval.

Clause 4: The method of any one or more of clauses 1-3, wherein the input sea level curve includes an eustatic curve.

Clause 5: The method of any one or more of clauses 1-4 further comprising determining a relationship between the geological time interval and depth of the well; and determining a depth for each of the one or more predicted systems tracts based on the relationship.

Clause 6: The method of any one or more of clauses 1-5 further comprising presenting the one or more predicted systems tracts on a depth scale, and wherein the predicted systems tracts are color coded based on a plurality of types.

Clause 7: The method of any one or more of clauses 1-6, wherein the types of systems tracts include highstand systems tracts, lowstand systems tracts, transgressive systems tracts, and falling stage systems tracts.

Clause 8: One or more tangible computer-readable mediums including instructions executable by one or more processors, the instructions comprising instructions to generate a training dataset including a plurality of sample systems tracts each associated with a respective sample rate of change of subsidence and a respective sediment supply; and instructions to train a learning machine to indicate predicted systems tracts for wells based on the plurality of sample system tracts and their respective sample rate of change of subsidence and respective sample sediment supplies.

Clause 9: The one or more tangible computer-readable mediums of clause 8, wherein the learning machine is implemented as a neural network, the method further comprising: instructions to determine an input sea level curve indicating rates of change of subsidence and an input sediment supply curve indicating sediment supplies; and instructions to determine, via the neural network, one or more predicted systems tracts through time for a well based on the input sea level curve and the input sediment supply curve.

Clause 10: The one or more tangible computer-readable mediums of any one or more of clauses 8-9 further comprising: instructions to determine a location of the well and a geological time interval.

Clause 11: The one or more tangible computer-readable mediums of any one or more of clauses 8-10, wherein the input sea level curve includes an eustatic curve.

Clause 12: The one or more tangible computer-readable mediums of any one or more of clauses 8-11, further comprising: instructions to determine a relationship between the geological time interval and depth of the well; and instructions to determine a depth for each of the one or more predicted systems tracts based on the relationship.

Clause 13: The one or more tangible computer-readable mediums of any one or more of clauses 8-12, further comprising: presenting the one or more predicted systems tracts on a depth scale, and wherein the predicted systems tracts are color coded based on type.

Clause 14: The one or more tangible computer-readable mediums of any one or more of clauses 8-13, wherein the types of systems tracts include highstand systems tracts, lowstand systems tracts, transgressive systems tracts, and falling stage systems tracts.

Clause 15: A system comprising: one or more processors; one or more tangible computer-readable mediums including instructions executable by the one or more processors, the instructions including instructions to generate a training dataset including a plurality of sample systems tracts each associated with a respective sample rate of change of subsidence and a respective sediment supply; and instructions to train a learning machine to indicate predicted systems tracts for wells based on the plurality of sample system tracts and their respective sample rate of change of subsidence and respective sample sediment supplies.

Clause 16: The system of clause 15, wherein the learning machine is implemented as a neural network, the method further comprising: instructions to determine an input sea level curve indicating rates of change of subsidence and an input sediment supply curve indicating sediment supplies; and instructions to determine, via the neural network, one or more predicted systems tracts through time for a well based on the input sea level curve and the input sediment supply curve.

Clause 17: The system of any one or more of clauses 15-16, 16 further comprising: instructions to determine a location of the well and a geological time interval.

Clause 18: The system of any one or more of clauses 15-17, wherein the input sea level curve includes an eustatic curve.

Clause 19: The system of any one or more of clauses 15-18 further comprising: instructions to determine a relationship between the geological time interval and depth of the well; and instructions to determine a depth for each of the one or more predicted systems tracts based on the relationship.

Clause 20: The system of any one or more of clauses 15-19, further comprising: analyzing forward stratigraphic modelling simulations to identify systems tracts for any rate of change of sea level, subsidence rate, sediment supply, sediment compaction, isostatic loading, and initial bathymetry.

What is claimed is:

1. A method comprising:
generating a training dataset including a plurality of sample systems tracts each associated with a respective sample rate of change of subsidence and a respective sediment supply; and
training a learning machine to indicate predicted systems tracts for wells based on the plurality of sample system tracts and their respective sample rate of change of subsidence and respective sample sediment supplies.

2. The method of claim 1, wherein the learning machine is implemented at a neural network, the method further comprising:
determining an input sea level curve indicating rates of change of subsidence and an input sediment supply curve indicating sediment supplies; and
determining, via the neural network, one or more predicted systems tracts through time for a well based on the input sea level curve and the input sediment supply curve.

3. The method of claim 2 further comprising:
determining a location of the well and a geological time interval.

4. The method of claim 2, wherein the input sea level curve includes an eustatic curve.

5. The method of claim 4 further comprising:
determining a relationship between the geological time interval and depth of the well; and
determining a depth for each of the one or more predicted systems tracts based on the relationship.

6. The method of claim 5 further comprising:
presenting the one or more predicted systems tracts on a depth scale, and wherein the predicted systems tracts are color coded based on a plurality of types.

7. The method of claim 6, wherein the types of systems tracts include highstand systems tracts, lowstand systems tracts, transgressive systems tracts, and falling stage systems tracts.

8. One or more tangible computer-readable mediums including instructions executable by one or more processors, the instructions comprising:
instructions to generate a training dataset including a plurality of sample systems tracts each associated with a respective sample rate of change of subsidence and a respective sediment supply; and
instructions to train a learning machine to indicate predicted systems tracts for wells based on the plurality of sample system tracts and their respective sample rate of change of subsidence and respective sample sediment supplies.

9. The one or more computer-readable mediums of claim 8, wherein the learning machine is implemented as a neural network, the method further comprising:
instructions to determine an input sea level curve indicating rates of change of subsidence and an input sediment supply curve indicating sediment supplies; and
instructions to determine, via the neural network, one or more predicted systems tracts through time for a well based on the input sea level curve and the input sediment supply curve.

10. The one or more computer-readable mediums of claim 9 further comprising:
instructions to determine a location of the well and a geological time interval.

11. The computer-readable medium of claim 9, wherein the input sea level curve includes an eustatic curve.

12. The one or more computer-readable mediums of claim 11 further comprising:
instructions to determine a relationship between the geological time interval and depth of the well; and
instructions to determine a depth for each of the one or more predicted systems tracts based on the relationship.

13. The one or more computer-readable mediums of claim 12 further comprising:
presenting the one or more predicted systems tracts on a depth scale, and wherein the predicted systems tracts are color coded based on type.

14. The one or more computer-readable mediums of claim 13, wherein the types of systems tracts include highstand systems tracts, lowstand systems tracts, transgressive systems tracts, and falling stage systems tracts.

15. A system comprising:
one or more processors;
one or more tangible computer-readable mediums including instructions executable by the one or more processors, the instructions including
instructions to generate a training dataset including a plurality of sample systems tracts each associated with a respective sample rate of change of subsidence and a respective sediment supply; and
instructions to train a learning machine to indicate predicted systems tracts for wells based on the plurality of sample system tracts and their respective sample rate of change of subsidence and respective sample sediment supplies.

16. The system of claim 15, wherein the learning machine is implemented as a neural network, the method further comprising:
instructions to determine an input sea level curve indicating rates of change of subsidence and an input sediment supply curve indicating sediment supplies; and
instructions to determine, via the neural network, one or more predicted systems tracts through time for a well based on the input sea level curve and the input sediment supply curve.

17. The system of claim 16 further comprising:
instructions to determine a location of the well and a geological time interval.

18. The system of claim 16, wherein the input sea level curve includes an eustatic curve.

19. The system of claim 18 further comprising:
instructions to determine a relationship between the geological time interval and depth of the well; and
instructions to determine a depth for each of the one or more predicted systems tracts based on the relationship.

20. The system of claim 15 further comprising:
analyzing forward stratigraphic modelling simulations to identify systems tracts for any rate of change of sea level, subsidence rate, sediment supply, sediment compaction, isostatic loading, and initial bathymetry.
